(19) United States
(12) Patent Application Publication
(10) Pub. No.: US 2014/0018489 A1
(43) Pub. Date: Jan. 16, 2014

(54) MIXED METAL POLYMER COMPOSITE

(71) Applicant: Michael H. Johnson, Katy, TX (US)

(72) Inventor: Michael H. Johnson, Katy, TX (US)

(73) Assignee: Baker Hughes Incorporated, Houston, TX (US)

(21) Appl. No.: 13/548,302

(22) Filed: Jul. 13, 2012

(51) Int. Cl. C08K 3/08

(52) U.S. Cl. CPC C08K 3/08
USPC 524/440; 264/122; 524/439; 524/441

(57) ABSTRACT

A metal-polymer composite includes a crosslinked polymer; and a metal which is removably disposed among the crosslinked polymer. A method of making the metal-polymer composite includes combining a crosslinked polymer and a metal; blending the crosslinked polymer and the metal to form a blend; cold pressing the blend; heating the blend to a forging temperature; and applying pressure to the blend at the forging temperature to form the metal-polymer composite. A downhole article includes a crosslinked polymer including a crosslinked product of a polymer including polyphenylene sulfide, polyphenylsulfone, self-reinforced polyphenylene, polysulfone, polyethersulfone, polyarylsulfone, derivatives thereof, or a combination comprising at least one of the foregoing; and a metal disposed among the crosslinked polymer and removable by contact with a downhole fluid.

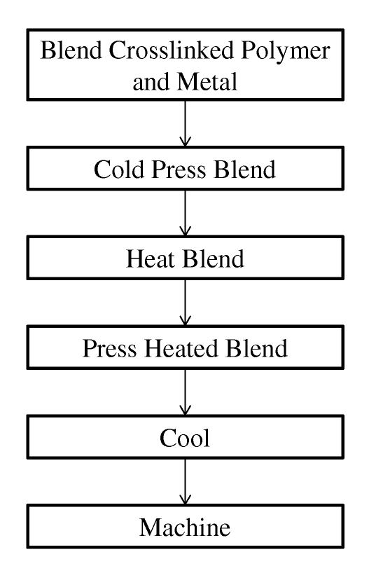

### BACKGROUND

Oil and natural gas wells often use borehole components or tools that, due to their function, only have limited service lives that are considerably less than the service life of the well. After a component or tool service function is complete, it must be removed or disposed of in order to recover the original size of the fluid pathway for use, including hydrocarbon production, CO₂ sequestration, etc. Disposal of components or tools has been done by milling or drilling the component or tool out of the borehole, which can be time consuming and expensive.

To eliminate the need for milling or drilling operations, the removal of components or tools by dissolution of degradable polylactic polymers using various borehole fluids has been proposed. However, these polymers generally do not have the mechanical strength, fracture toughness, and other mechanical properties to perform the functions of borehole components or tools across the operating temperature range of the borehole; therefore, their application has been limited.

Materials that can be used to form borehole components and tools having the mechanical properties to perform their intended function with subsequent removal from the borehole by dissolution using borehole fluids would be well received in the art.

### BRIEF DESCRIPTION

The above-described and other deficiencies of the art are met by a metal-polymer composite comprising: a crosslinked polymer; and a metal which is removably disposed among the crosslinked polymer.

In another embodiment, a method of making a metal-polymer composite comprises combining a crosslinked polymer and a metal; blending the crosslinked polymer and the metal to form a blend; cold pressing the blend; heating the blend to a forging temperature; and applying pressure to the blend at the forging temperature to form the metal-polymer composite.

In yet another embodiment, a downhole article comprises a crosslinked polymer including a crosslinked product of a polymer including polyphenylene sulfide, polyphenylsulfone, self-reinforced polyphenylene, polysulfone, polyethersulfone, polyarylsulfone, derivatives thereof, or a combination comprising at least one of the foregoing; and a metal disposed among the crosslinked polymer and removable by contact with a downhole fluid.

The above described and other features are exemplified by the following detailed description.

### BRIEF DESCRIPTION OF THE DRAWINGS

The following descriptions should not be considered limiting in any way. With reference to the accompanying drawings, like elements are numbered alike:

The FIGURE shows a flow diagram of a process of making a metal-polymer composite.

### DETAILED DESCRIPTION

A detailed description of one or more embodiments of the disclosed apparatus, composition, and method are presented herein by way of exemplification and not limitation with reference to the FIGURE.

It has been found that metal-polymer composites herein including a crosslinked polymer and removable metal provide strong, stable, dense materials. Such materials are useful in numerous environments and have corrosion rates that are controllable.

According to an embodiment, a metal-polymer composite includes a crosslinked polymer and a metal. The metal is removably disposed among the crosslinked polymer. By removing the metal from the composite, the polymer can be porous. Alternatively, the composite can decompose upon removal of a portion of the metal effective to cause decomposition of the composite.

In an embodiment, the metal is an electrolytic material, which dissolves in a corrosive environment, such as under saline conditions (i.e., an environment having a concentration of halide and/or formate salt in an amount effective to cause corrosion of the metal), reducing conditions, acidic conditions, and the like. Such electrolytic material is referred to herein as controlled electrolytic material (CEM). The controlled electrolytic material, which is discussed further below, can be an electrolytic metal such as described in U.S. patent application Ser. No. 13/194,271, the content of which is incorporated herein by reference in its entirety. Removal of the metal from the metal-polymer composite causes degradation of the composite.

The metal can be any metal as long as the metal in the metal-polymer composite can be forged or sintered below the degradation temperature of the crosslinked polymer. The metal can include an element from Group 2, Group 3, Group 4, Group 5, Group 6, Group 7, Group 8, Group 9, Group 10, Group 11, Group 12, Group 13, lanthanoid series, actinoid series of the periodic table, or a combination comprising at least one of the foregoing. In a non-limiting embodiment, the metal is aluminum (Al), cadmium (Cd), calcium (Ca), californium (Cf), cobalt (Co), copper (Cu), chromium (Cr), gallium (Ga), indium (In), iron (Fe), magnesium (Mg), manganese (Mn), molybdenum (Mo), nickel (Ni), palladium (Pd), tin (Sn), titanium (Ti), tungsten (W), silicon (Si), silver (Ag), yttrium (Y), zinc (Zn), zirconium (Zr), an alloy thereof, or a combination thereof. It is believed that these metals can be used in a downhole environment and can be corroded by a suitable corrosion agent. Also, such metals can be stable in a downhole environment for extended periods of time (for example a week to a number of years), or the metal can be corroded at a nominal rate that does not adversely affect the structure or functionality of the metal-polymer composite until exposure to the corrosion agent.

Additionally, the metal-polymer composite can include other corrodible metals, metal oxides, composites, soluble glasses, and the like. Useful corrodible materials dissolve under an aqueous condition. According to an embodiment, alloying or trace elements can be included in varying amounts to adjust the corrosion rate of the metal. For example, four of these elements (cadmium, calcium, silver, and zinc) have to mild to moderate accelerating effects on corrosion rates, whereas four others (copper, cobalt, iron, and nickel) have a still greater effect on corrosion. Commercial magnesium alloys, which include different combinations of the above alloying elements, can achieve different corrosion rates and include (although not limited to), for example, those alloyed with aluminum, strontium, and manganese such as AJ62, AJ50x, AJ51x, and AJ52x alloys, and those alloyed with aluminum, zinc, and manganese such as AZ91A-E alloys.

It will be appreciated that alloys having corrosion rates greater than those of the above exemplary alloys are contemplated as being useful herein. For example, nickel has been found to be useful in decreasing the corrosion resistance (i.e., increasing the corrosion rate) of magnesium alloys when included in small amounts (i.e., less than 1% by weight). In an embodiment, the nickel content of a magnesium alloy is less than or equal to about 0.5 weight percent (wt %), specifically less than or equal to about 0.4 wt %, and more specifically less than or equal to about 0.3 wt %, based on the weight of the metal, to provide a useful corrosion rate for the metal-polymer composite. In an exemplary embodiment, magnesium particles are alloyed with about 0.25 wt % Ni, based on the weight of the metal. Similar ranges are applicable to other metal alloys disclosed herein.

The above alloys are useful as the metal in the metal-polymer composite and are formed into the desired shape and size by, for example, milling, casting, forging, machining, or a combination thereof. Alternatively, powders of the metal (including alloys thereof) are useful for forming part of the metal-polymer composite. Such metal powders can have a particle size of from about 100 nanometers (nm) to about 900 micrometers (μm), specifically about 500 nm to about 700 μm, and more specifically about 1 μm to about 250 μm. The powder can be further coated using a method such as chemical vapor deposition, anodization or the like, or admixed by a physical method such as cryo-milling, ball milling, or the like, with a metal or metal oxide such as Al, Ni, W, Co, Cu, Fe, oxides of one of these metals, or the like. Such coated metal powders are examples of controlled electrolytic material (CEM). The metal (e.g., CEM material) can be molded or compressed with the crosslinked polymer into a desired shape by, for example, cold compression using an isostatic press at about 40 kilopounds per square inch (kpsi) to about 110 kpsi (about 275 megapascals (MPa) to about 759 MPa) followed by forging and/or sintering then machining, to provide a desired shape and dimension of the metal-polymer composite.

It will be understood that the metal will thus have any corrosion rate necessary to achieve the desired performance of the metal-polymer composite and articles including the composite, e.g., a downhole article such as a flapper valve. In an embodiment, the metal (e.g., CEM material) used in the metal-polymer composite has a corrosion rate of about 0.1 milligram per square centimeter per hour (mg/cm²/hr) to about 20 mg/cm²/hr, specifically about 1 mg/cm²/hr to about 15 mg/cm²/hr in, for example, an aqueous 3 wt % KCl solution (based on the weight of the solution) at 200° F. (93° C.), which can be even greater in other corrosion agents. The corrosion rate can be adapted to be below these ranges for a particular application of the metal-polymer composite.

In addition to the metal, the metal-polymer composite includes a crosslinked polymer. According to an embodiment, the crosslinked polymer is the reaction product of crosslinking a polymer that contains a phenyl group and a heteroatom such as sulfur and/or oxygen in its backbone. Examples of the polymer useful for crosslinking include polyphenylene sulfide (PPS), polyphenylsulfone (PPSU), self-reinforced polyphenylene (SRP), polysulfone, polyethersulfone, polyarylsulfone, derivatives thereof, or a combination comprising at least one of the foregoing. For a crosslinked polymer that includes multiple polymers, the relative amount and identity of each polymer can be varied to tune the properties of the crosslinked polymer and the metal-polymer composite. In an exemplary embodiment, the particular polymers are selected and used in relative amounts to produce a crosslinked polymer having a glass transition temperature (Tg) so that the metal-polymer composite is useful in and can withstand downhole conditions of temperature, pressure, and the like, including temperatures encountered within a high temperature well. In a specific embodiment, the particular polymers are selected and used in relative amounts to produce a crosslinked polymer having a glass transition temperature of about 40° C. to about 400° C., specifically about 45° C. to about 350° C., and more specifically about 50° C. to about 300° C. According to a non-restrictive embodiment, the crosslinked polymer includes polyphenylene sulfide, polyphenylsulfone, and self-reinforced polyphenylene crosslinked together. In an embodiment, the amount of each polymer is about 20 wt % to about 90 wt % polyphenylene sulfide, about 20 wt % to about 90 wt % polyphenylsulfone, and about 20 wt % to about 90 wt % and self-reinforced polyphenylene, based on the weight of the crosslinked polymer.

The polymer is linear or branched and includes homopolymers or copolymers which include two or more of the foregoing exemplary polymers. Copolymers include random, alternating, graft, and block copolymers having two or more blocks of different homopolymers, random, or alternating copolymers. The polymers can further be chemically modified to include, for example, functional groups or can be oxidized, hydrogenated, etc. Exemplary polymers include polyphenylene sulfides with either a branched structure, such as those marketed under the trade name RYTON® by Chevron-Phillips, or a linear structure, such as those marketed under the trade name FORTRON® by Ticona. The polymer can be obtained and used in either pellet or powder form.

The polymer can have a weight averaged molecular weight (Mw) of about 500 grams per mole (g/mol) to about 100,000 g/mol, more specifically about 500 g/mol to about 80,000 g/mol, and more specifically about 500 g/mol to about 60,000 g/mol. In addition, the polymer has a melt flow, determined according to ASTM D 1283 at 316° C. under a 5 kg load, of greater than or equal to about 1 g/10 minutes, in another embodiment greater than or equal to about 10 g/10 minutes, and in another embodiment greater than about 50 g/10 minutes. Also, the polymer has a melt flow, determined according to ASTM D 1283 at 316° C. under a kg load, of less than or equal to about 7,500 g/10 minutes, in another embodiment less than or equal to about 6,500 g/10 minutes, and in another embodiment less than or equal to about 5,500 g/10 minutes.

The polymer is linear or branched, having a number of branches of greater than or equal to 1, in another embodiment greater than or equal to 2, and in another embodiment greater than or equal to 5 branching points per 1,000 carbon atoms along the polymer chain.

In a non-limiting embodiment, a phenyl group in the backbone of the polymer can be derivatized to include a functional group. Exemplary functional groups include but are not limited to alkyl, alkenyl, alkynyl, alkoxy, haloalkyl, aryl, arylalkyl, aryloxy, arylalkyloxy, heteroaryl, heteroaralkyl, amine, hydroxy, carboxyl, halogen, or a combination comprising at least one of the foregoing. Without wishing to be bound by any particular theory, it is believed that such functional groups aid the dispersion of the crosslinked polymer among the metal to obtain a more uniform and homogeneous distribution of these components. Moreover, the functional groups may also contribute to forging or sintering the metal and densification during processing of these materials to form the metal-polymer composite.

In an exemplary embodiment, in the metal-polymer composite, the metal can be present in an amount of about 20 wt % to about 99.5 wt %, specifically about 30 wt % to about 99 wt %, and more specifically about 30 wt % to about 80 wt %, based on the weight of the metal-polymer composite. The amount of the crosslinked polymer can be about 0.5 wt % to about 40 wt %, specifically about 1 wt % to about 30 wt %, and more specifically about 5 wt % to about 25 wt %, based on the weight of the metal-polymer composite.

In another embodiment, the polymer is compounded with an additive prior to crosslinking and then crosslinked. Additionally or alternatively, an additive can be combined with the crosslinked polymer and metal before further processing to form the metal-polymer composite. “Additive” as used herein includes any compound added to the polymer (e.g., polyphenylene sulfide) or combination of polymers (e.g., polyphenylsulfone and self-reinforced polyphenylene) to adjust the properties of the crosslinked polymer, for example a blowing agent to form a foam, a filler, or processing aid, provided that the additive does not substantially adversely impact the desired properties of the product (i.e., the crosslinked polymer), for example corrosion resistance at high temperature. Exemplary additives include a filler, processing aid, crosslinker, peroxide initiator, and the like. It is contemplated that combinations of the additives are useful together.

Compounding includes, for example, combining uncured polymer (e.g., powder or pellets) with the additive under conditions to blend these components together. Compounding can be performed in a ball-mill for blending and grinding, two-roll mill, vibratory mill, attritor, high shear blending process, or acoustic blending process such as by using a Resodyn Acoustic Mixer. The compounding can also be melt-compounding such as by a twin-screw extruder.

Fillers include, for example, reinforcing and non-reinforcing fillers. Non-limiting examples of reinforcing filler are silica, glass fiber, carbon fiber, or carbon black, which can be added to the polymer matrix to increase strength. Non-reinforcing fillers such as polytetrafluoroethylene (PTFE), molybdenum disulfide (MoS₂), or graphite can be added to the polymer matrix to increase the lubrication. Nanofillers are also useful, and are reinforcing or non-reinforcing. Nanofillers, such as carbon nanotubes, nanographenes, nanoclays, polyhedral oligomeric silsesquioxane (POSS), or the like, can be incorporated into the polymer matrix to increase the strength and elongation of the material. Nanofillers can further be functionalized to include grafts or functional groups to adjust properties such as solubility, surface charge, hydrophilicity, lipophilicity, and other properties. Silica and other oxide minerals can also be added to the composition. Combinations comprising at least one of the foregoing fillers can be used.

A processing aid is a compound included to improve flow, moldability, and other properties of the crosslinked polymer. Processing aids include, for example, an oligomer, a wax, a resin, a fluorocarbon, or the like. Exemplary processing aids include stearic acid and derivatives, low molecular weight polyethylene, and the like. Combinations comprising at least one of the foregoing processing aids can be used.

The polymer can be crosslinked either alone or in the presence of an ancillary polymer in order to obtain a desired property of the crosslinked polymer. However, the presence of the ancillary polymer may reduce chemical resistance. Thus, in an embodiment, no ancillary polymer is present during crosslinking of the polymer. If used, in order to maintain the desired properties of the crosslinked product, any amount of the ancillary polymer is limited, being present for example in amount of about 0.01 to about 20 weight percent (wt %), about 0.1 to about 10 wt %, or about 1 to about 5 wt % of the total weight of the polymer present. For example, if used, aromatic thermoplastic polymers can be present, such as aromatic polyamides, polyimides, polyetherimides, polyaryletherketones (PAEK), polyetherether ketones (PEEK), polyether sulfones (PESU), polyphenylene sulfone ureas, or the like, or combinations comprising at least one of the foregoing. Ancillary polymers containing oxygen include, for example, acetal resins (e.g., polyoxymethylene (POM)), polyester resins (e.g., poly(ethylene terephthalate) (PET), poly(butylene terephthalate) (PBT), and poly(ethylene naphthalate) (PEN)), polyarylates (PAR), poly(phenylene ether) (PPE), polycarbonate (PC), aliphatic polyketones (e.g., polyketone (PK)), poly(ether ketones) (polyetherketone (PEK), polyetherketoneketone (PEKK), and polyetherketone etherketone ketone (PEKEKK)), and acrylic resins (e.g., polymethylmethacrylate (PMMA)) can be used. The ancillary polymer can be linear or branched, homopolymers or copolymers, and used alone or in combination with one or more other aromatic thermoplastic polymers. Copolymers include random, alternating, graft, and block copolymers, the block copolymers having two or more blocks of different homopolymers, random copolymers, or alternating copolymers. The ancillary polymers can further be chemically modified to include, for example, functional groups such as halogen, alcohol, ether, ester, amide, etc. groups, or can be oxidized, hydrogenated, and the like.

According to another embodiment, a reactive elastomer or fluoropolymer can be blended with the polymer before crosslinking the polymer to form the crosslinked polymer. Such reactive elastomer or fluoropolymer can graft to the polymer during crosslinking to increase flexibility of the crosslinked polymer. In a further embodiment, the reactive elastomer or fluoropolymer can be added to the crosslinked polymer (instead of or in addition to before crosslinking the polymer) and metal for processing to make the metal-polymer composite. Exemplary reactive elastomers or fluoropolymers include polytetrafluoroethylene (PTFE), nitrile-butyl rubber (NBR), hydrogenated nitrile-butyl rubber (HNBR), high fluorine content fluoroelastomers rubbers such as those in the FKM family and marketed under the trade name VITON® fluoroelastomers (available from FKM-Industries), perfluoroelastomers such as FFKM (also available from FKM-Industries) marketed under the trade name KALREZ® perfluoroelastomers (available from DuPont) and Chemraz®(available from Green, Tweed and Co.), VECTOR® adhesives (available from Dexco LP), organopolysiloxanes such as functionalized or unfunctionalized polydimethylsiloxanes (PDMS), tetrafluoroethylene-propylene elastomeric copolymers such as those marketed under the trade name AFLAS® and marketed by Asahi Glass Co., ethylene-propylene-diene monomer (EPDM) rubbers, polyvinylalcohol (PVA), and the like, and combinations comprising at least one of the foregoing polymers. In an embodiment, the crosslinked polymer is combined with an FKM fluoropolymer such as a copolymer of vinylidene fluoride and hexafluoropropylene; terpolymer of vinylidene fluoride, hexafluoropropylene, and tetrafluoroethylene; copolymer of vinylidene fluoride, hexafluoropropylene, and tetrafluoroethylene, and perfluoromethylvinylether; copolymer of propylene, tetrafluoroethylene, and vinylidene fluoride; copolymers of vinylidene fluoride, hexafluoropropylene, tetrafluoroethylene, perfluoromethylvinylether, and ethylene, or a combination comprising at least one of the foregoing.

In a non-limiting embodiment, the crosslinked polymer is prepared by crosslinking the polymer in the presence of a molecular crosslinking agent. Crosslinking agents include gas, solid, or liquid crosslinking agents such as peroxides, sulfur, metal oxides, or sulfur donor agents. With respect to an embodiment, the crosslinked polymer is a reaction product of the crosslinker including sulfur, silica, a quinone, a peroxy compound, a metal peroxide, a metal oxide, or a combination comprising at least one of the foregoing crosslinkers.

Peroxides can be used for crosslinking, for example organic peroxides such as ketone peroxides, diacyl peroxides, dialkyl peroxides, peroxyesters, peroxyketals, hydroperoxides, peroxydicarbonates, and peroxymonocarbonates. Examples of specific peroxides include 2,2-bis(t-butylperoxy)butane, 1,3 1,4-bis(tert-butylperoxyisopropyl)benzene, dicumyl peroxide, tert-butylcumylperoxide, 2,5-dimethyl-2,5-di-(tert-butylperoxy)hexane, n-butyl-4,4′-di(tert-butylperoxy)valerate, 1,1′-di(tert-butylperoxy)-3,3,5-trimethylcyclohexane, and the like; or inorganic peroxides such as calcium peroxide, zinc peroxide, hydrogen peroxide, peroxydisulfate salts, and the like. Commercially available peroxides include those marketed by Arkema, Inc. under the tradename DI-CUP® including, DI-CUP® dialkyl peroxide, DI-CUP® 40C dialkyl peroxide (on calcium carbonate support), DI-CUP® 40K dialkyl peroxide, DI-CUP® 40KE dialkyl peroxide; and alkyl diperoxy compounds including 2,5-dimethyl-2,5-di(t-butylperoxy) hexane and marketed by Akzo-Nobel under the tradename TRIGONOX® 101. Effective amounts of peroxides can be readily determined by one of skill in the art depending on factors such as the reactivity of the peroxide and the polymer herein, the desired degree of cure, and like considerations, and can be determined without undue experimentation. For example, peroxides can be used in amounts of about 1 to about 10 parts per 100 parts by weight of the polymer. Sulfur can also be used for crosslinking, for example, elemental sulfur, hydrogen sulfide, or sulfur donor agents. Examples of sulfur donor agents include alkyl polysulfides, thiuram disulfides, and amine polysulfides. Some non-limiting examples of suitable sulfur donor agents are 4,4′-dithiomorpholine, dithiodiphosphorodisulfides, diethyldithiophosphate polysulfide, alkyl phenol disulfide, tetramethylthiuram disulfide, 4-morpholinyl-2-benzothiazole disulfide, dipentamethylenethiuram hexasulfide, and caprolactam disulfide. In another embodiment, sulfur can be used in amounts of about 1 to about 10 parts per 100 parts by weight of the polymer. Sulfur can also be used for crosslinking, for example elemental sulfur or hydrogen sulfide. Combinations of the foregoing crosslinking agents can be used.

According to an embodiment, the crosslinked polymer includes sulfur incorporated into the crosslinks in an amount from about 0.01 wt. % to about 5 wt. %, specifically about 0.05 wt. % to about 1.5 wt. %, and more specifically about 0.09 wt. % to about 1.1 wt. % based on the weight of the polymer.

Other agents to initiate or accelerate cure can also be present, for example amine accelerators, sulfonamide accelerators, and the like. Effective amounts of a crosslinking agent, activator, and the like can be determined without undue experimentation.

Crosslinking in the presence of a peroxide, sulfur, or other molecular crosslinking agent can be carried out at ambient pressure, at a partial pressure lower than ambient, or at elevated pressures (greater than 1 atmosphere). When peroxides, sulfur, or another gas, solid, or liquid crosslinking agent is used, the agent is generally compounded with the polymer, which is then crosslinked. The crosslinking agent can be pre-dispersed in a master batch and added to the polymer to facilitate mixing.

In an embodiment, the polymer can be crosslinked in the presence or absence of oxygen. In an embodiment, oxygen is used as a portion of the atmosphere as either pure oxygen or a mixture of gases. Where a mixture of gases is used, oxygen is mixed with any suitable inert gas such as, for example, nitrogen, helium, argon, carbon dioxide, or the like. In an embodiment, curing is carried out in air. Here again, ambient pressure can be used, or a partial pressure lower than ambient, or at elevated pressures (>1 atmosphere).

Crosslinking with peroxides, sulfur, or other crosslinking agents can be thermally induced and, thus, carried out at elevated temperatures for a time and at a pressure effective to achieve the desired degree of crosslinking. In an non-limiting embodiment, crosslinking is carried out at a temperature of about 150° C. to about 600° C. (or higher), about 200° C. to about 500° C., and more specifically about 300° C. to about 450° C. The crosslinking is conducted for a total time of about 200 hours or less, about 72 hours or less, about 48 hours or less, or about 1 to about 48 hours. In an embodiment, crosslinking is conducted at about 300° C. to about 375° C. for about 1 to about 20 hours, specifically about 2 to about 6 hours, in air atmosphere at ambient pressure. In another exemplary embodiment, curing is carried out at a temperature of about 350° C. to about 375° C., for a time of about 1 hour to about 200 hours, in the absence of oxygen and at ambient pressure. It will be understood that where the crosslinking temperature is close to or at the thermal decomposition temperature of the polymer, a combination of crosslinking temperature and time is used such that during crosslinking, the crosslinked polymer exhibits a weight loss of less than 10%, specifically less than 5% weight loss, and more specifically less than 1% weight loss. According to an embodiment, the crosslinking of the polymer is performed at a temperature greater than the Tg of any individual polymer constituent. In an embodiment, the crosslinking is performed at a temperature greater than the melting temperature (Tm) of any individual polymer constituent. In some embodiments, the crosslinking is conducted at a temperature at or above the glass transition temperature of the crosslinked polymer and for a time effective to provide the crosslinked polymer.

The crosslinked polymer can be partially cured, or fully cured. Where the crosslinked polymer is fully cured, it can be completely amorphous, without showing a melting temperature (Tₘ) transition by, for example, differential scanning calorimetry (DSC) which corresponds to the melting of any of the crystalline regions of the semi-crystalline high temperature crosslinked polymer. Alternatively, the crosslinked polymer can be partially cured, where analysis by DSC shows a reduction in the heat flow at the melting temperature (Tₘ) relative to that of the uncured polymer. Where the crosslinked polymer is only partially cured, the crosslinked polymer is semi-crystalline. As used herein, “semi-crystalline” means having a degree of crystallinity less than that of the uncured polymer. For example, where the polymer is about 30% crystalline (based on weight or volume) prior to curing, the crosslinked polymer can be about 10% crystalline after partial cure. Partial cure may also be localized, based on the degree of exposure of the polymer to the oxygen atmosphere during curing. For example, where the polymer is provided as a pellet or particle, partial cure can be obtained where the outermost, exposed portion (surface or layer) of a particle of the crosslinked polymer is cured and has a low crystallinity (e.g., less than or equal to about 5% crystallinity, in another embodiment less than or equal to about 2% crystallinity, and in another embodiment less than or equal to about 1% crystallinity, based on weight or volume), or is fully amorphous, while the interior of the pellet or particle is uncured. The portion cured, in this instance, corresponds to the diffusion depth of the oxygen into the pellet or particle during cure, and varies with cure condition, i.e., temperature, pressure, oxygen concentration, and time.

The degree of crosslinking can be regulated by controlling reaction parameters such as crosslinking temperature, crosslinking time, and crosslinking environment, for example, varying the relative amounts of the polymer and crosslinking agent. Degree of cure can be monitored using a number of methods. Once crosslinked, these polymers do not dissolve in solvents. In an advantageous feature, solubility can be used to examine whether or not a polymer is crosslinked. Other methods that can be used to examine molecular crosslinking include Dynamic Mechanical Analysis (DMA). This method monitors and records material modulus at different temperatures. For amorphous polymers, the modulus drops to near zero when the temperature is increased to above the Tg. Material tends to flow at high temperature above Tg. In contrast, crosslinked polymers will maintain a rubber-like plateau having relatively high modulus at a wide temperature range above its glass transition temperature. The crosslinked polymer can be partially crosslinked as described above.

After the crosslinked polymer is formed by crosslinking the polymer, the crosslinked polymer can be comminuted prior to further processing (such as combining with the metal). Comminuting is done by any suitable method including use of a commercial blender, mortar and pestle, ball mill, grinder, an extruder (followed by, e.g., cutting of the extruded material to produce pellets) or the like, so long as the particle size of the resultant comminuted crosslinked polymer is suitable for adequate mixing. Any suitable particle size can be obtained by the comminuting. In an embodiment, the crosslinked polymer is pulverized into a particle size of less than or equal to about 10 mesh, specifically less than or equal to about 20 mesh, more specifically less than or equal to about 40 mesh, and even more specifically less than or equal to about 300 mesh. It will be understood that “less than” a mesh size refers to particle size defined by mesh number that is inversely correlated to particle size, i.e., the higher the mesh number, the smaller the particle size. Thus, in an embodiment, the particles size relative to the largest linear dimension of the crosslinked polymer particles can be about 20 mesh or smaller. In an embodiment, the particles size is about 10 micrometers (μm) to about 1000 μm, specifically about 100 μm to about 750 μm, and more specifically about 250 μm to about 500 μm. Similarly, the metal can be used as received as a metal powder from a vendor (e.g., magnesium powder, available from Goodfellow Corp.) or comminuted to produce appropriately sized particles for processing to form the metal-polymer composite. Although communiting the crosslinked polymer and metal are described above to produce powders thereof, other methods may be used to be used to produce powders of the metal and crosslinked polymer.

According to an embodiment, as shown in the FIGURE, a method of making the metal-polymer composite includes combining the crosslinked polymer and the metal, blending the crosslinked polymer and the metal to form a blend, cold pressing the blend, heating the blend to a forging temperature, and applying pressure to the blend at the forging temperature to form the metal-polymer composite. It is contemplated that the crosslinked polymer and/or metal are in a powder form. Alternatively, the crosslinked polymer could be pellets or fibers such that the metal (e.g., in powder form) is combined with such crosslinked polymer. Blending the crosslinked polymer and the metal produces a blend with a substantially uniform composition. Examples of blending include ball milling, roller milling, grinding, high-shear blending, acoustic blending, and the like. In some embodiments, blending is a combination of these processes. The blend is subsequently disposed in a press and pressurized. The press is, for example, a cold hydrostatic press operated at a temperature less than the sintering or forging temperature of the metal and also less than the melting temperature of the crosslinked polymer. The temperature during cold pressing can be, for example, about −20° C. to about 100° C., specifically about 0° C. to about 70° C., and more specifically about 10° C. to about 50° C. The pressure can be increased to about 20,000 pounds per square inch (psi) to about 120,000 psi, specifically about 30,000 psi to about 110,000 psi, and more specifically about 40,000 psi to about 100,000 psi. The rate of pressurization can affect the densification of the blend and can be less than 8000 pounds per second (pps), specifically less than 3000 pps, and more specifically less than 100 pps. Cold pressing densifies the blend to a solid that is about 25% dense to about 90% dense, specifically about 40% dense to about 85% dense, and more specifically about 60% dense to about 80% dense. The cold pressed blend can have a certain level (i.e., numerical amount) of voids in the material. Thus, for an 80% dense blend, the blend can have a number of voids within the solid.

After cold pressing, the blend is heated to the forging temperature of the metal, and pressure is applied to the heated blend at a temperature to form the metal-polymer composite. In an embodiment, the blend is heated to a temperature of about 350° F. (about 176° C.) to about 1200° F. (about 650° C.), specifically about 375° F. (about 190° C.) to about 1100° F. (about 594° C.), and more specifically about 400° F. (about 204° C.) to about 1000° F. (about 538° C.). In an embodiment, the temperature is less than the sintering temperature of the metal. In another embodiment, the temperature is about the sintering temperature of the metal. In some embodiments, the temperature is greater than the sintering temperature of the metal. The pressure used can be from about 20,000 pounds per square inch (psi) to about 120,000 psi, specifically about 30,000 psi to about 110,000 psi, and more specifically about 40,000 psi to about 100,000 psi, while the blend is maintained at an elevated temperature, which can be greater than or about the forging temperature of the metal, particularly equal to or greater than the forging temperature. The pressing time can be from about 5 seconds to about 5 hours, specifically about 10 seconds to about 3 hours, and more specifically about 20 seconds to about 30 minutes. During heating and pressing, the temperature of the blend is not allowed to obtain a value (for a period of time long enough) to cause decomposition of the crosslinked polymer. Additionally, heating and applying pressure occur in an inert atmosphere, for example, under a noble gas (e.g., argon, helium) or nitrogen. In this manner, the metal-polymer composite is produced.

During application of pressure at (or near) the forging temperature of the metal, the blend becomes more dense than the density of the blend from the cold pressing. In an embodiment, heating and pressurizing the blend produces a metal-polymer composite that is greater than or equal to 85% dense, specifically greater than or equal to 90% dense, more specifically greater than or equal to 95% dense, even more specifically greater than or equal to 99% dense, and yet even more specifically greater than or equal to 99.9% dense. According to an embodiment, heating and pressurizing the blend can remove voids from the cold pressed blend. In an embodiment, the density of the metal-polymer composite can be controlled by the temperature and pressure used during heating and pressing. Moreover, in a non-limiting embodiment, the metal in the metal-polymer composite can be sintered during the heating and pressurization.

According to another embodiment, the blend can be disposed in an extruder such that the blend is heated and densification occurs during extrusion of the blend at high pressure as the blend of metal and crosslinked polymer traverses the die of the extruder. In this manner, the pressure and temperature can be controlled to compress the material to a suitable density of the metal-polymer composite.

Although the forging temperature at about one atmosphere for some metals can be greater than the decomposition temperature of some polymers, the crosslinked polymers (and blends thereof) herein are thermally stable to the elevated temperatures used under the pressure conditions herein. Additionally, metals useful in the metal-polymer composite have a forging temperature below the decomposition temperature of the crosslinked polymers herein.

After heating and applying pressure to make the metal-polymer composite, the metal-polymer composite can have any shape depending on the pressurization device (e.g., a diamond anvil, cast, mold, extruder, and the like). Exemplary shapes include a billet, block, annulus, disc, hub, shaft, spoke, rod, sleeve, cylinder, flat, polygon, round, plate, and the like. Metal-polymer composites herein can be produced as finished or with allowance (in its volume or size) for further machining to a final size or shape.

In an additional embodiment, the metal-polymer composite is shaped to form an article, e.g., by machining. Exemplary shaping processes include machining with a computer numerical control machine (CNC), lathe, lapping table, electric discharge machine (EDM), extruder, hacksaw, band saw, drill press, and the like. Likewise, a combination comprising these may be used to shape the metal-polymer composite. The shape can be selected based on a number of factors such as final application of the article, machining time, shipping constraints, and the like.

The metal-polymer composites have excellent physical properties, including thermal stability such that the metal-polymer is stable at a temperature of at least about 200° C., specifically at least about 250° C., more specifically at least about 325° C., even more specifically at least about 400° C., and yet even more specifically about at least 450° C. In an embodiment, the metal-polymer composite can withstand temperatures greater than the crosslinked polymer. That is, the metal-polymer composites can have a thermal decomposition temperature greater than 200° C., specifically at least about 250° C., more specifically at least about 325° C., even more specifically at least about 400° C., and yet even more specifically about at least 450° C.

The metal-polymer composite further can have a strength from about 50 megapascals (MPa) to about 1000 MPa, specifically about 100 MPa to about 1000 MPa, and more specifically about 200 MPa to about 1000 MPa.

In some embodiments, the metal can be removed from the metal-polymer composite. The removal of the metal can be partial or complete removal. When metal is removed from the metal-polymer composite, the metal-polymer composite can have pores disposed in it produced by removal of the metal. In a specific embodiment, the metal can be removed from the metal-composite polymer, and the metal-polymer composite can remain intact as a porous matrix containing the crosslinked polymer. In a further embodiment, the metal can be removed from the metal-polymer composite, leading to decomposition of the metal-polymer composite. The decomposition can be partial or complete. In a complete decomposition, the metal-polymer composite can disintegrate. Such complete decomposition is useful in applications where removal of the metal-polymer composite is desired. Thus, in a method of decomposing the metal-polymer composite, the metal-polymer composite can be disposed in an environment and exposed to environmental conditions to decompose the metal-polymer composite. The environmental conditions can include temperature, pressure, fluid, or a combination comprising at least one of the foregoing. Fluids include those that cause decomposition by removal of the metal or, alternatively (or additionally), decomposition of the crosslinked polymer. Exemplary fluids include brine (e.g., mineral brine containing halide ions, alkali metal ions, alkaline earth metal ions, transition metal ions, formate ions, and the like), acid, base, aqueous solvent including transition metal ions, chelant (e.g., amino carboxylic acid compounds such as ethylene diamine tetraacetic acid, citric acid, and the like), or a combination comprising at least one of the foregoing.

Shaped, formed, machined, forged, or molded articles comprising the metal-polymer composite are also provided. The metal-polymer composites can be pressed into useful shaped articles by a variety of means such as hot pressing, extrusion, low-temperature sintering (that is, at a sintering temperature well-below the sintering temperature for high melting temperature refractive metals such as platinum) to form articles such as, for example, downhole articles such as a sleeve, ball, ball seat, flapper valve, plug, tubular, liner, screen, sieve, packer, and the like. In addition, the metal-polymer composite can be used for such applications as a seal, including a temporary seal. In a specific embodiment, the article of the metal-polymer composite can be used in a high temperature well, for example, as a drop ball to set a packer, where the crosslinked polymer acts as binder to reduce the corrosion rate of the metal and also to maintain the strength of the composite so that the ball seals to set that packer at the high well temperature, e.g., 700° F. Subsequently the ball may be contacted with a downhole fluid (e.g., brine) so that it decomposes, leaving the wellbore unobstructed for production. In this way, the downhole article does not interfere with production after the packer is set.

In an embodiment, a downhole article includes a crosslinked polymer including a crosslinked product of a polymer including polyphenylene sulfide, polyphenylsulfone, self-reinforced polyphenylene, polysulfone, polyethersulfone, polyarylsulfone, derivatives thereof, or a combination comprising at least one of the foregoing; and a metal disposed among the crosslinked polymer and removable by contact with a downhole fluid. The metal can include aluminum, magnesium, tungsten, calcium, cobalt, copper, chromium, gallium, indium, iron, manganese, molybdenum, palladium, tin, titanium, tungsten, silicon, yttrium, zinc, or a combination comprising at least one of the foregoing. Further, the downhole article can be a sleeve, ball, flapper valve, plug, tubular, liner, screen, sieve, packer, and the like. The downhole article can be a temporary seal such that the downhole article is porous after removal of the metal, which is caused by decomposition when contacted by a downhole fluid.

The metal-polymer composite is further illustrated by the following non-limiting example.

Polyphenylene sulfide, polyphenylsulfone, and self-reinforced polyphenylene pellets were combined with a crosslinking agent and mechanically blended. The mixture was heated to 150° C. to cure the polymers, providing a crosslinked polymer. The temperature was decreased, and the crosslinked polymer was triturated to produce a powder of the crosslinked polymer, which was combined with magnesium and aluminum powders in a commercial blender. After producing a uniform blend of the crosslinked polymer and metal powders, the blend was placed in a cold isostatic press at room temperature and pressed at 90,000 psi for 5 minutes to produce a billet that 85% dense. Subsequently, the billet was transferred to a diamond anvil and heated to a forging temperature under an inert nitrogen atmosphere. A pressure of 100,000 psi was applied for about 5 minutes to produce a billet of the metal-polymer composite that was 99.9% dense. The temperature and pressure were decreased to room temperature and atmospheric pressure, and the billet was placed in an extruder. After extrusion, the metal-polymer composites were each about 8 pounds cylinders having a diameter of about 5″ and a height of about 5″.

The aluminum and magnesium were partially removed from the composite by introducing the composite into a vat of brine (4 wt % sodium chloride, based on the weight of the brine) at 80° C.

While one or more embodiments have been shown and described, modifications and substitutions may be made thereto without departing from the spirit and scope of the invention. Accordingly, it is to be understood that the present invention has been described by way of illustrations and not limitation.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A metal-polymer composite comprising:
a crosslinked polymer; and
a metal which is removably disposed among the crosslinked polymer.

2. The metal-polymer composite of claim 1, wherein the metal includes aluminum, magnesium, tungsten, calcium, cobalt, copper, chromium, gallium, indium, iron, manganese, molybdenum, palladium, tin, titanium, silicon, yttrium, zinc, or a combination comprising at least one of the foregoing.

3. The metal-polymer composite of claim 2, wherein the metal is present in an amount of about 30 wt % to about 99 wt %, based on the weight of the metal-polymer composite.

4. The metal-polymer composite of claim 1, wherein the crosslinked polymer is a crosslinked product of a polymer including polyphenylene sulfide, polyphenylsulfone, self-reinforced polyphenylene, polysulfone, polyethersulfone, polyarylsulfone, derivatives thereof, or a combination comprising at least one of the foregoing.

5. The metal-polymer composite of claim 4, wherein the amount of the crosslinked polymer is about 0.5 wt % to about 25 wt %, based on the weight of the metal-polymer composite.

6. The metal-polymer composite of claim 4, wherein the polymer is compounded with an additive comprising a filler, processing aid, ancillary polymer, crosslinker, peroxide initiator, or a combination comprising at least one of the foregoing before crosslinking and inclusion in the metal-polymer composite.

7. The metal-polymer composite of claim 6, wherein the crosslinked polymer is a reaction product of the crosslinker including sulfur, silica, a quinone, a peroxy compound, a metal peroxide, a metal oxide, or a combination comprising at least one of the foregoing crosslinkers.

8. The metal-polymer composite of claim 6, wherein the crosslinked polymer comprises an elastomer or fluoropolymer with the polymer before crosslinking, wherein the elastomer or fluoropolymer grafts to the polymer during crosslinking to increase flexibility of the crosslinked polymer.

9. The metal-polymer composite of claim 1, wherein the metal-polymer composite is stable at a temperature greater than 370° C.

10. A method of making a metal-polymer composite, comprising:
combining a crosslinked polymer and a metal;
blending the crosslinked polymer and the metal to form a blend;
cold pressing the blend;
heating the blend to a forging temperature; and
applying pressure to the blend at the forging temperature to form the metal-polymer composite.

11. The method of claim 10, wherein blending comprises ball milling, roller milling, grinding, high-shear blending, acoustic blending, or a combination comprising at least one of the foregoing.

12. The method of claim 10, wherein cold pressing occurs at a temperature of less than the sintering temperature of the metal and less than the melting temperature of the crosslinked polymer.

13. The method of claim 10, wherein cold pressing renders the blend at least 80% dense.

14. The method of claim 10, wherein the forging temperature is about 400° F. (about 204° C.) to about 1000° F. (about 538° C.).

15. The method of claim 10, wherein applying pressing is at a pressure of about 40,000 psi to about 110,000 psi.

16. The method of claim 10, wherein applying pressure and heating forge the metal and form the metal-polymer composite which is equal to or greater than 99% dense.

17. A downhole article comprising:
a crosslinked polymer including a crosslinked product of a polymer including polyphenylene sulfide, polyphenylsulfone, self-reinforced polyphenylene, polysulfone, polyethersulfone, polyarylsulfone, derivatives thereof, or a combination comprising at least one of the foregoing; and
a metal disposed among the crosslinked polymer and removable by contact with a downhole fluid.

18. The downhole article of claim 17, wherein the metal includes aluminum, magnesium, tungsten, calcium, cobalt, copper, chromium, gallium, indium, iron, manganese, molybdenum, palladium, tin, titanium, tungsten, silicon, yttrium, zinc, or a combination comprising at least one of the foregoing.

19. The downhole article of claim 17, wherein the downhole article includes a sleeve, ball, flapper valve, plug, tubular, liner, screen, sieve, or a packer.

20. The downhole article of claim 17, wherein the downhole article decomposes when contacted by a downhole fluid.
